(19) United States
(12) Patent Application Publication
(10) Pub. No.: US 2019/0191722 A1
(43) Pub. Date: Jun. 27, 2019

(54) Method And Device For Treating Dough

(71) Applicant: König Maschinen Gesellschaft m.b.H, Graz (AT)

(72) Inventors: Dieter Sönnichsen, Burg (DE); Josef Hefner, Dürrwangen (DE); Johann Thormählen, Kollmar (DE); Gernot Maier, Hart bei Graz (AT); Hannes Stelzer, Lannach (AT)

(21) Appl. No.: 16/326,118

(22) PCT Filed: Aug. 14, 2017
(86) PCT No.: PCT/AT2017/060201

§ 371 Date: Feb. 15, 2019

(30) Foreign Application Priority Data
Aug. 18, 2016 (AT) A50742/2016

(51) Int. Cl. A21C 11/00

(52) U.S. Cl. CPC A21C 11/006

(57) ABSTRACT

A method and a device for treating dough, in particular for producing pizza bases, wherein a piece of dough is applied on a support, in particular an abutment or a conveyor belt, and pressure is applied to the piece of dough by means of a pressure stamp, which includes a number of concentrically arranged press rings so that the dough flows. The press rings are extended one after the other outwardly in a staggered manner from the center of the press rings in the direction of the support such that the surface of the piece of dough is increased.

### TECHNICAL FIELD

The present teaching relates to a method for treating dough, in particular for producing pizza bases, according to the present teaching as well as a device in accordance with the present teaching.

### BACKGROUND

The prior art includes various known methods and devices with which dough for pizzas or other pastries are shaped by a stamp or an array of rollers.

One device known from the prior art, for example, is disclosed in patent DE 102007006395 A1, in which pizza bases are produced by being rolled or punched out on a pad. In addition, patent EP 2174549 A1 discloses an apparatus for pressing pizza bases, comprising a number of concentric rings, which are applied on the piece of dough one after the other in a staggered manner and thus shape the pizza base.

A disadvantage of the devices and methods known from the prior art is that, for the most part, only pizza bases with a constant cross-section and/or uniform thickness can be produced and it tends to be difficult or completely impossible to adjust the thickness of a pastry. In addition, the dough is subjected to continuous pressure, possibly causing negative flow behavior and tears in the dough.

### SUMMARY

It is therefore one object of the present teaching to provide a method by which the production of dough is improved and negative impacts of mechanical processing on the dough are reduced.

This object is achieved by means of the characteristic features of the present teachings, which foresee that the press rings are extended one after the other outwardly in a staggered manner from the center of the press rings in the direction of the support, and the surface of the piece of dough below is enlarged.

The staggered lowering of the press rings also causes an advantageous spreading of the dough and ensures an unimpeded flow of dough.

It is likewise an object of the present teaching to provide a device for performing the inventive method or for the production of pastries, said device allowing on the one hand simple adjusting of the thickness profile of a pastry that is to be produced and on the other hand providing simple adjustment mechanisms for modifying the processing profile of the pieces of dough.

This object is achieved by means of the characteristic features of the present teachings, which foresees that a propulsion device is provided by which the press rings can be moved along their ring axis like a telescope, independently of one another, from a first position into a second position.

The press rings' ability to slide independently makes it possible to use different pressing profiles and pressing processes and to produce various shapes for dough and/or for the piece of dough that is to be produced.

Particularly advantageous embodiments of the method and of the device are presented in greater detail by means of the features in the dependent claims.

The flowing motion of the dough can additionally be improved if adjacent press rings in each case are applied to the dough one after the other outwardly from the center of the pressure stamp and reshape the dough, and after application of the respective adjacent press rings, they are withdrawn again, so that at all times only a partial number of the press rings, in particular a number of adjacent press rings, are in contact with the piece of dough.

Advantageous reshaping of the dough is achieved if the pressure of the press rings is adjusted in such a way that, after extending the radially most outward of the press rings, the piece of dough has the predetermined shape of the pastry, in particular of a pizza base.

The shape of the completed pastry can be additionally improved in that the distance between the individual press rings and the support of the piece of dough and/or the pressing time and/or pressing force is predetermined for every press ring before and/or during the pressing procedure.

A preferred configuration of the device is achieved if in each case the press ring situated closer to the ring axis has a slightly smaller outer diameter than the inner diameter of the adjacent press ring situated farther away from the ring axis and if the press rings can be slid into one another.

Preferred positions of the device are those in which the press rings in the first position are disposed co-planarly in one plane and constitute a flat front surface of the pressure stamp and in the second position are at various distances to the support, in particular the abutment, and/or, with the support, in particular the abutment, the press rings configure a negative shape of the pastry to be produced.

The distance between press ring and support, as well as the pressing force and the pressing duration, can preferably be selected in that the propulsion device comprises a camshaft powered by a motor or in some other way, so that by rotating the camshaft the press rings can be moved from the first position along the ring axis like a telescope, in particular independently of one another, into the second position.

A preferred embodiment of the present teaching foresees that the press rings comprise a recess, which in particular passes completely through them, running radially to the press rings, so that the camshaft is inserted into the recess, coaxially with the course of the recess, and at least one cam of the camshaft impacts one press ring in each case and is adjacent with it in the recess.

Free play between the press ring and the cam of the camshaft is advantageously prevented if the recess is of circular configuration and the cams are configured in such a way that every cam is supported on two radially opposite points of the wall of the recess.

Preferred force distribution from the camshaft to the press rings is achieved in that the press rings comprise a recess that passes completely through them, surrounding them radially, such that the camshaft is inserted into the recess and positioned coaxially to the recess and extends over the entire recess above the press rings, such that the camshaft impacts every press ring with two identically configured cams in each case on two points diametrically opposite to the ring axis of the press rings.

In one embodiment, for the prevention of wear, the force transmission between cam and rings can be configured by means of a gliding agent, such as plastic, or by rollers or the like.

Advantageous adjustment of the exit depth or minimum distance between the press rings and the support is obtained in that at least one restricting device is provided, which limits the sliding of the press rings with respect to one another along the ring axis and/or fixes the distance of the press rings from the support, in particular the abutment, preferably in the second position.

To provide a preferred configuration of the restricting device, said device is configured by at least one wedge, such that the wedge is positioned between a cam and the press ring.

A preferred embodiment of the device is achieved in that the press rings can be rotated about their ring axis, in particular at an angle, and
that a wedge pair is disposed between each press ring and the cam contiguous with the respective press ring at two radially opposite points of the wall of the recess,
that the first and the second wedge of the pair are configured as a wedge ring, in particular as a wedge ring segment, and have the same center diameter as the press ring on which the respective wedge is mounted and are disposed congruent with it,
that the first wedge and second wedge over one section each have a varying thickness, in particular uniform thickness increase or thickness decrease, in the direction of the ring axis of the press rings and comprise a plane of contact with the respective cam that is steeply positioned with respect to the radius of the press rings, such that the planes of contact of the first wedge and of the second wedge with the respective cam run parallel to one another and so that the distance of the respective press ring to the support, in particular the abutment, can be modified by rotating the press rings.

An additional embodiment of the device can be achieved if every press ring can be moved with the cams, in each case by the pressure rod contiguous with one of the cams, such that the pressure rods are disposed in such a way that on rotating the camshaft the press rings can be moved out of the first position, along the ring axis like a telescope, in particular independently of one another, into the second position. The configuration and arrangement by means of pressure rods allows exact and simple movement of the pressure stamp with simultaneous minor wear of individual components.

In an advantageous embodiment, the camshaft is disposed perpendicular to the ring axis and intersects said axis, in particular at the halfway point of the camshaft, such that the camshaft comprises in each case two identically configured cams, which are positioned diametrically opposite on the camshaft, and such that in each case a press ring is movably connected with a cam by means of a pressure rod and, in particular situated diametrically opposite the ring axis of the press rings, is movably connected with the second identically configured cam by means of an additional pressure rod.

Friction between the pressure rods and the cams can be reduced if the pressure rods each comprise, on the end contiguous with the cams, a roller contiguous with the periphery of the respective cam, such that the respective roller is positioned so that it rolls out upon rotation of the camshaft on the periphery of the respective cam.

The pressure rods can be steered easily if the pressure rods are positioned parallel to the ring axis, such that the pressure rods are each fed into at least one guide sheath while each guide sheath is supported on the housing of the device or of the pressure stamp.

To be able to easily prevent any lifting of the pressure rods from the cams, the pressure rods can each be force-impactable by means of a spring, in particular a pressure spring, such that the respective spring is configured and mounted in such a way that the respective pressure rod can be pressed in the direction of the cams.

To be able to define the border of a pastry, or to be able to shape it advantageously, it is foreseen that the pressure stamp should comprise a border ring, such that the border ring comprises a negative shape of the border of the pastry to be produced by the device.

It is advantageous for the border ring to have a greater diameter than the largest of the press rings, or for the border ring to be mounted on the largest of the press rings.

It is advantageous if the shape of the pastry to be produced is preset and if soiling of the press rings is prevented in that at least one separator element, in particular an elastic element, in particular a membrane and/or a shape, in particular a pizza shape, is positioned between the press rings and the support, in particular the abutment.

An advantageous embodiment of the device is obtained if the device comprises two identically configured pressure stamps, such that the two pressure stamps are situated opposite one another and the press rings of the first pressure stamp and the press rings of the second pressure stamp are positioned concentrically with one another and such that the first pressure stamp and the second pressure stamp each configure the support, in particular the abutment, of the other pressure stamp.

The device can advantageously be transported and deployed anywhere desired along a manufacturing chain, in that the first pressure stamp and/or the second pressure stamp is mounted on a moveable frame, in particular a roller wagon.

To press a piece of dough of any size into pastries it is foreseen that the distance between the first pressure stamp and the second pressure stamp is adjustable.

It is advantageous to foresee that the device comprises at least one adjustment device, such that the adjustment device is linked to the pressure stamp and such that the pressure stamp can be moved by the adjustment device along the ring axis, in particular in the direction of the support, preferably of the abutment, or
that preferably the device comprises two adjustment devices, such that the first adjustment device is linked to the first pressure stamp and the second adjustment device is linked to the second pressure stamp and such that the first pressure stamp and second pressure stamp can be moved by the adjustment device along the ring axis of the respective pressure stamp, in particular independently of one another.

Preferred configurations of the adjustment device can be provided in that the adjustment device, in particular the adjustment devices, can be a hydraulic cylinder, a pneumatic cylinder or a linear motor.

Alternatively, this can also occur by means of other powering forms, such as an eccentric tappet, a curve disc, chains, toothed racks.

Other advantages and configurations of the present teaching can be seen from the description and the attached drawings.

### BRIEF DESCRIPTION OF THE DRAWINGS

The present teaching is schematically depicted hereinafter with reference to the particularly advantageous embodiments, which however are not to be considered restrictive, in the drawings and it is described by way of example with reference to the drawings, which are as follows:

FIG. 1 shows a pressure stamp of an inventive device in a perspective view.

FIG. 2 shows a section view of the pressure stamp in a first position.

FIG. 3 shows a section view of the pressure stamp in a second position.

FIG. 4 shows a partial section view of the pressure stamp in an isometric view.

FIG. 5 shows a perspective view of the rear side of the pressure stamp.

FIG. 6 shows a wedge ring in a perspective view.

FIGS. 6a and 6b show a pressing procedure in accordance with the inventive method.

FIG. 7 shows an embodiment of the present teaching in perspective view.

FIG. 8 shows an embodiment of the inventive device in section view.

FIG. 9 shows an additional embodiment in a section view.

FIG. 10 shows a section view of the embodiment in accordance with FIG. 9.

### DETAILED DESCRIPTION

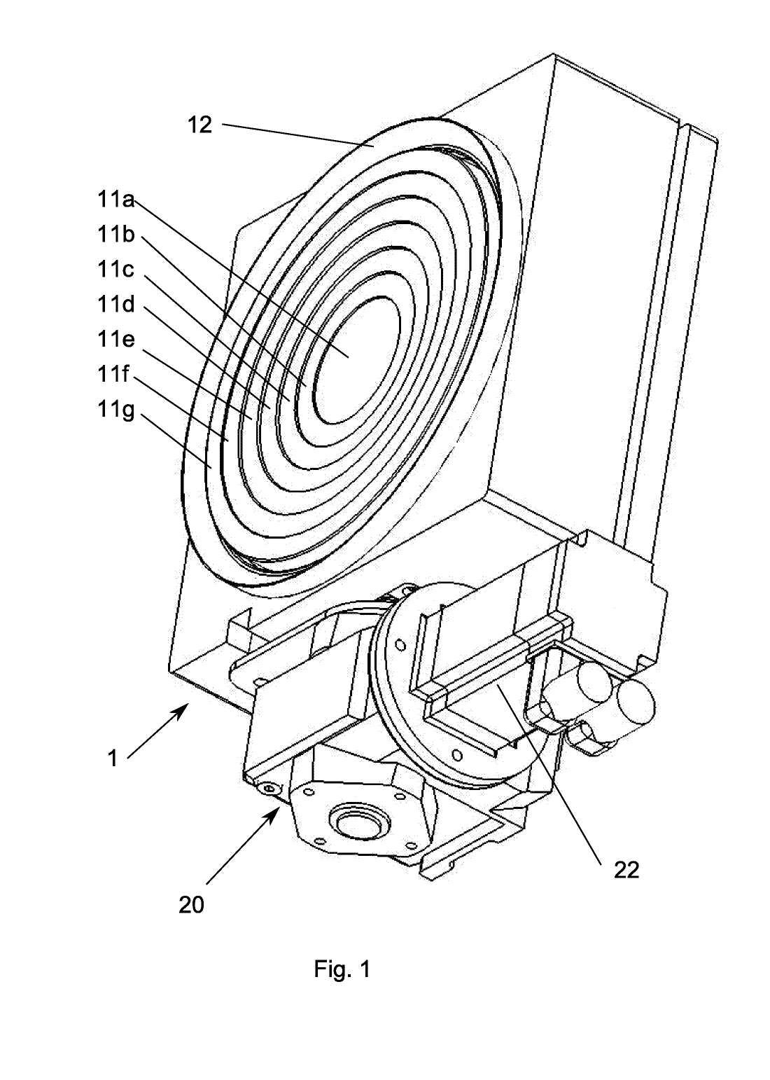

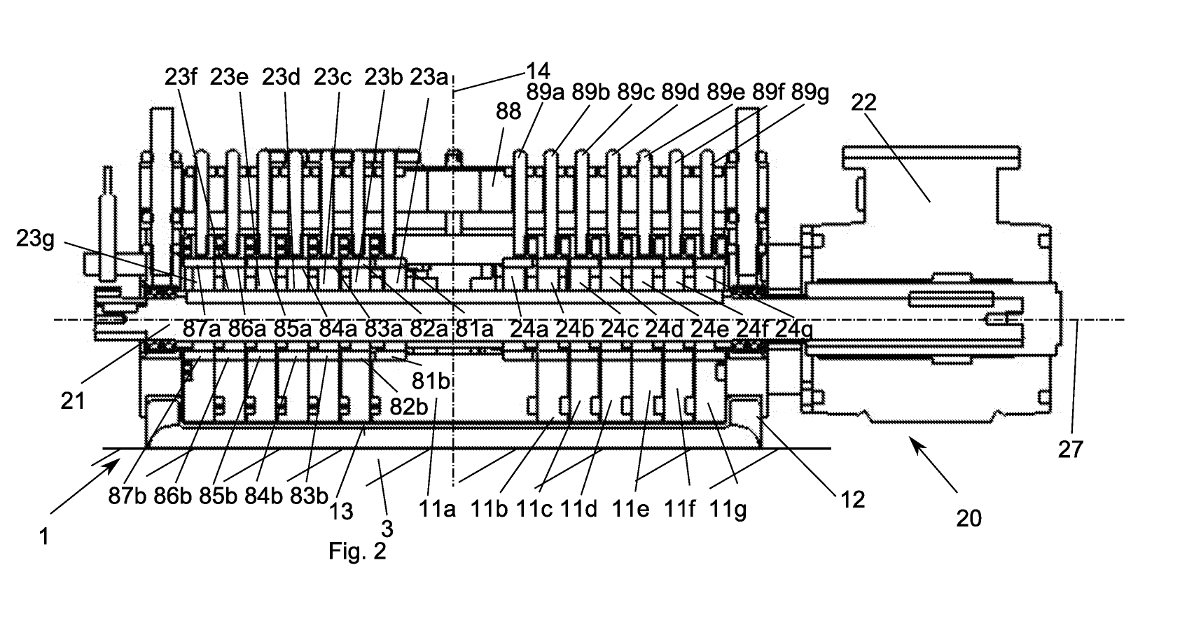

FIG. 1 is a perspective depiction of the pressure stamp 1 viewed in the direction toward its underside or toward the press rings 11a, 11b, 11c. The inventive device 10 for processing dough comprises at least one pressure stamp 1. An embodiment of the pressure stamp is illustrated in FIG. 1. The pressure stamp 1 includes seven press rings 11a-11g, such that the first press ring 11a is positioned in the center of the press rings 11a-11g. The first press ring 11a is of cylindrical configuration. The second press ring 11b is positioned around the first press ring 11a. The press ring 11b is disposed concentrically on a plane with the press ring 11a and its inside is contiguous with the first press ring 11a. The third press ring 11c, fourth press ring 11d, fifth press ring 11e, sixth press ring 11f and seventh press ring 11g are situated concentrically with the first press ring 11 and are positioned staggered, one beside the other. The first press ring 11a thus comprises a slightly smaller outer diameter than the inner diameter of the second press ring 11b, and so on. Analogously to the outer diameter of the first press ring 11a and the inner diameter of the second press ring 11b, the other press rings 11c-11g are each telescopically mounted in one another, such that each set of adjacent press rings, such as press ring 11b with press ring 11c or press ring 11c with press ring 11d, are positioned so that they can slide toward one another with respect to their ring axis 14. Press rings 11a-11g are each mounted and steered on the inner circumference and the outer circumference on the neighboring press rings 11b to 11g. Guidance of the press rings 11a-11g allows sliding of the press rings 11-11g with respect to one another and thus makes possible a staggered sliding of the individual press rings 11a-11g. The pressure stamp 1 on one of its side surfaces comprises a propulsion device 20, positioned on the pressure stamp 1. The propulsion device 20 includes a camshaft 21 (FIG. 2 through FIG. 4) and an electric motor 22, which can rotate the camshaft 21 in its axis 27. A border ring 12 is positioned on the pressure stamp 1 around the largest or outermost press ring 11g. The press rings 11a-11g comprise a level front surface and in a first position (FIG. 2) are coplanarly positioned in a plane and in the first position form a level front surface 13 of the pressure stamp 11.

FIG. 2 is a section view of the pressure stamp 1 in a first position. The press rings 11a-11g are positioned in the first position coplanarly, so that their front ends configure a flat front surface 13 of the pressure stamp 1. The press rings 11a-11g are positioned so that they can slide telescopically toward one another in the ring axis, independently of one another. The pressure stamp 1 comprises a recess 15 running radially to the ring axis 14 of the press rings 11a-11g, which passes completely through the press rings 11a-11g and the pressure stamp 1. The propulsion device 20 in this embodiment comprises a motor 22 and a camshaft 21. The camshaft 21 here is completely inserted in the recess 15 and runs coaxially to the circularly or cylindrically shaped recess 15. The camshaft 21 comprises fourteen cams 23b through 23g and 24a through 24g. The camshaft 21 here is inserted in such a way in the recess 15 that seven of the cams 23b through 23g come down on one side with respect to the ring axis 14 and the seven other cams 24a through 24g are situated on the diametrically opposite side of the ring axis 14. The cams 23b through 23g and 24a through 24g each impact or touch one press ring 11a through 11g. The cams 23b through 23g and 24a through 24g here are arranged in pairs, so that the respective cam pairs 23a and 24a impact the same press ring 11a and thus are positioned diametrically opposite the ring axis 14 along the camshaft 21. The cams 23a through 23g or 24a through 24g of the camshaft 21 are, in addition, contiguous with two diametrically opposite points of the wall of the recess 15 or of the axis 27 of the camshaft 21. Upon rotation of the camshaft 21 in its axis 27, the press ring 11a through 11g linked in each case to the cams 23a through 23g or 24a through 24g is moved or slid in the direction of the ring axis 14 and slides in each case along the adjacent press ring 11a-11g, for example the third press ring 11c, on the two press rings 11b and 11d and is guided by it. The pressure stamp 1, in addition, comprises a border ring 12, whose inner diameter is configured larger than the outer diameter of the largest press ring 11g. The border ring 12 here comprises a negative shape of the border of the pastry that is to be pressed and in this embodiment comprises a semicircular press shape.

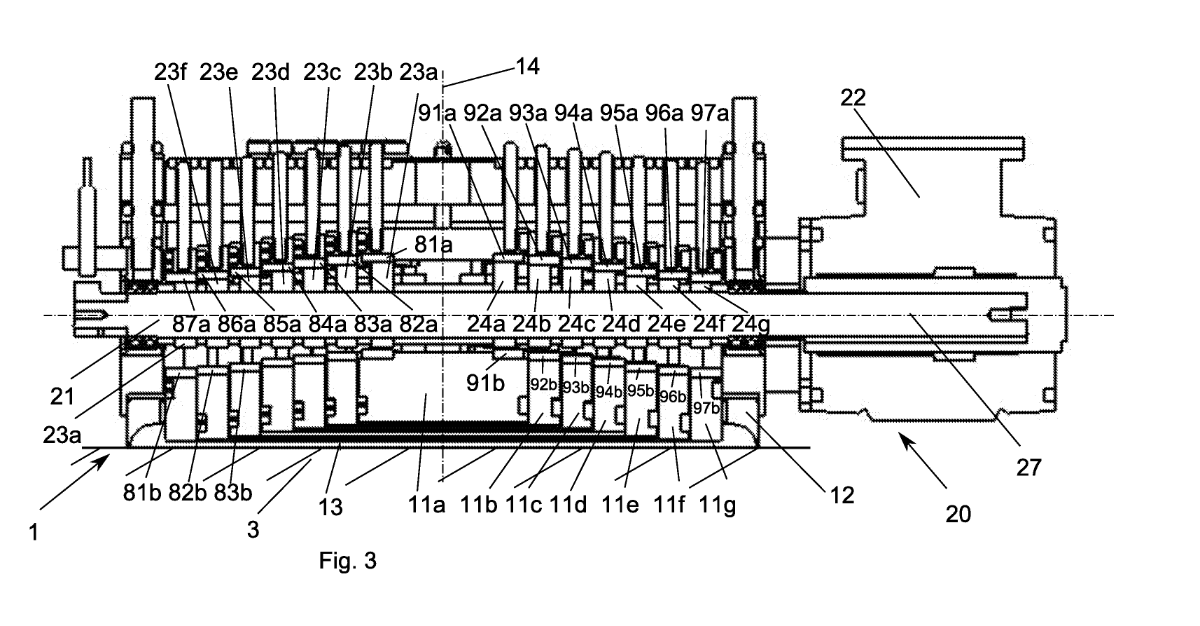

FIG. 3 shows the pressure stamp 1 of the inventive device 10 in a second position in accordance with the section view depicted in FIG. 2. The second position of the press rings 11a-11g occurs, for example, after the pressing operation of one piece of dough, such that in this second position the press rings 11a-11g are positioned staggered with respect to one another and the outermost press ring 11g is extended the farthest outward. The shape of the cams 23a through 24g here determines the position of the press rings 11a through 11g with respect to one another or the course of the position of the press rings 11a through 11g to one another and their distance to the support 13 or to the piece of dough.

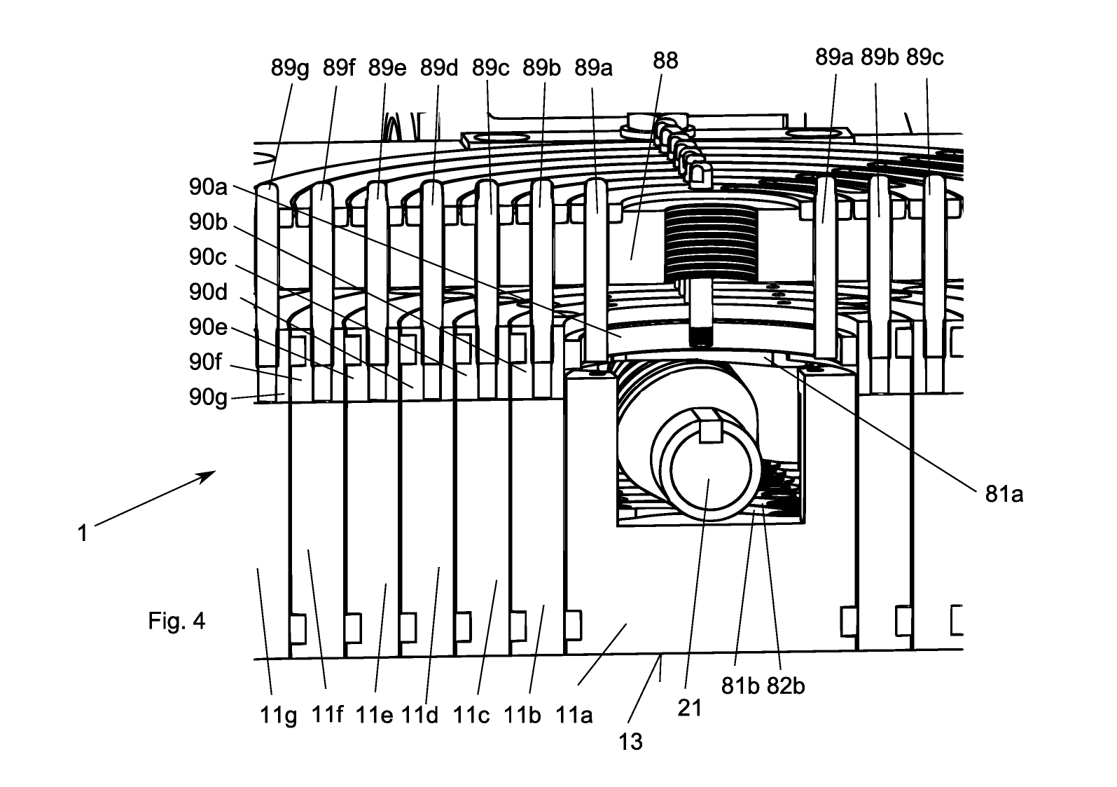

The device 10, in addition, includes a restricting device, which selects and pre-sets the minimum and maximum distance of the press rings 11a through 11g from the support 3 or the abutment. A detail view of the restricting device is shown in FIG. 4. The restricting device in this embodiment consists of a wedge system. One wedge pair 81 through 87 and 91 through 97 (FIG. 2, FIG. 3) is disposed between each cam 23a through 24g and the respective press ring 11a through 11g. The wedge pairs 81 through 87 and 91 through 97 are disposed here diametrically opposite the ring axis 14 in each case, between the respective press ring 11a through 11g and the corresponding cam 23a through 23g and 24a through 24g. The wedge pair 81 connects the cam 23a with the press ring 11a, and the wedge pair 91, positioned diametrically with respect to the ring axis 14, is analogously positioned between the cam 24a and the press ring 11a. Likewise, the other wedge pairs 82 through 87 and 92 through 97 are each, with respect to the ring axis 14, disposed in pairs between two cams, for example cams 23b and 24b, and the second press ring 11b. The maximum or minimum distance between the respective press ring 11a through 11g and the support 3 is modified and adjusted depending on the thickness of the wedge pair 81 (FIG. 2, FIG. 3). The wedge pair 81 thus consists, as do the other wedge pairs 82 through 97, of a first wedge 81a and a second wedge 81b, which are each positioned diametrically opposite between the respective cam 23a through 24g and the wall of the recess 15 or the respective press ring 11a through 11g.

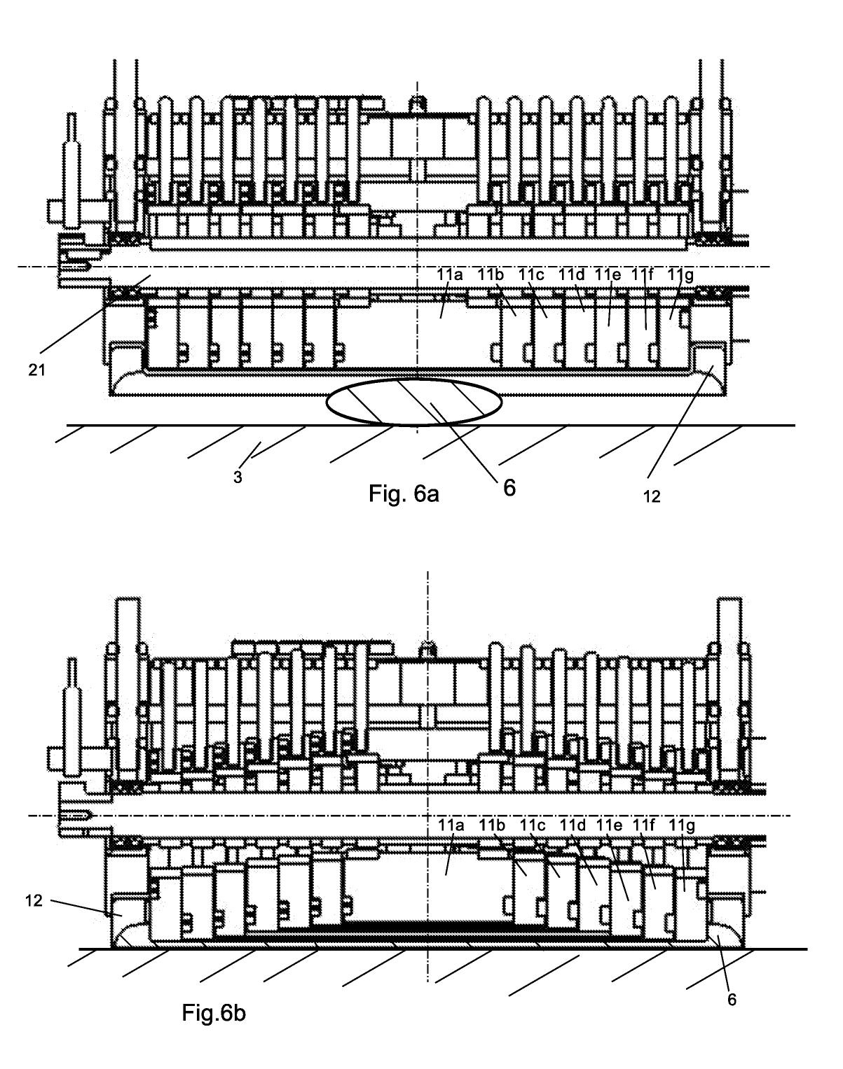

FIG. 6 shows a detail view of a wedge, here the second wedge 82b, which has the same curvature as the press ring 11b with the cam 23b and is positioned congruent with the press ring 11b (FIG. 2, FIG. 3, FIG. 4). The first wedges 81a through 87a or the second wedges 81b through 87b are each configured as wedge ring segments and each have the same center diameter as the press rings 11a, 11 b through 11g, on which the respective wedge 81a through 87b is disposed. The wedges 81a through 87b have a varying thickness along their circular periphery, such that the thickness increases uniformly along the periphery, or increases or decreases uniformly from one end of the wedge 81a through 87b (FIG. 6) to its other end. The increase or decrease in thickness of the wedges 81a through 87b configures a steep plane, inclined with respect to the base surface of the respective wedge 81a through 87b, as illustrated in FIG. 6 for the wedge 82b. The respective wedge pair 81 through 87 in each case thus constitutes, with the respective cam 23a through 24g of camshaft 21, two contact planes situated parallel to one another. The thickness of the first wedge 81a or second wedge 81b, which are situated between the camshaft 21 and the press ring 11a, determines the position of the press ring 11a with respect to the camshaft 21 (FIG. 4). By rotating one of the wedges 81a, 81b or the wedge pair 81 or the wedge pairs 81 through 87 or 91 through 97 about the ring axis 14 and thus the modification of the thickness of the wedge pair 81 contiguous with the cam 11a, the exit depth or distance between the respective press ring 11a through 11g and the support 13 or the abutment is adjusted. Rotating the other wedge pairs 82 through 87 or 91 through 97 analogously with the wedge pair 81 likewise causes an adjustment of the distance to the support 3 of the press ring 11b through 11g disposed in each case on the wedge pair 82 through 87.

To adjust the wedge pairs 81 through 87 and 91, the first wedges 81a through 87a and 91a through 97a are each disposed on an adjustment ring 90a through 90g, such that in each case the adjustment rings 90a through 90g have the same inner diameter and outer diameter as the press rings 11a through 11g placed in each case below them (FIG. 4) and are disposed by means of it on the front surface of the press rings 11a through 11g distant from the support 13. To suspend the adjustment rings 90a through 90g and the press rings 11a through 11g, there are four guide pins 89a through 89g foreseen in each case, which suspend or store the adjustment rings 90a through 90g or the press rings 11a through 11g on a support plate 88. The support plate 88 in each case, in the area of the guide pins 89a through 89g, comprises a recess similar to a longitudinal hole running over a peripheral area, through which the guide pins 89a through 89g can be rotated in these recesses and thus the press rings 11a through 11g or the adjustment rings 90a through 90g can be rotated within an angle. By rotating the press rings 11a through 11g or the adjustment rings 90a through 90g, the thickness of the wedges or wedge pairs 81 through 97 positioned on them is modified and thus the exit depth of the press rings 11a through 11g or the distance between the press rings 11a and 11g and that of the support 13 is modified.

The inventive method for the production or processing of dough, in particular the production of pizza bases, is described hereinafter by way of example with reference to FIG. 6a and FIG. 6b:

To produce pizza bases or other pastries, a piece of dough 6, illustrated in FIG. 6a, is laid on the support 3 of the device 10 (FIG. 2, FIG. 3). The pressure stamp 1 is positioned above the support 3, so that the innermost press ring 11a comes to rest over the piece of dough 6. The press rings 11a through 11g are then placed in a series on the piece of dough 6, so that the dough of the piece of dough 6 begins to flow. For said purpose, the press rings 11a through 11g from the first position (FIG. 2), in which the press rings 11a through 11g are in coplanar position and configure a flat front surface 13 of the pressure stamp 1, are lowered one after the other, staggered from the innermost press ring 11a to the outermost press ring 11g, so that the press rings 11a through 11g act on the piece of dough 6 and so that the piece of dough 6 increases its surface under the pressure of the press rings 11a through 11g. The press ring 11a is the first to be moved from the first position downward in the direction of the support 3 and acts on the piece of dough 6, so that it increases its surface. By rotating the camshaft 21, the press rings 11b, 11c through 11g are then lowered one after the other and act in sequence on the piece of dough 6. The cams 23a through 24g or the camshaft 21 are thus configured in such a way that a process of lowering the press rings 11a through 11g follows, and after a predetermined pressing duration the respective press ring 11a through 11g is again lifted off the reshaped piece of dough 6. Thus at any time only a part of the press rings 11a through 11g is in contact with the piece of dough 6, such that the press rings then in contact are each adjacent press rings. The lowering movement of the press rings, which is caused by the camshaft 21, is equivalent here to a wave-shape, which, starting from the center of the pressure stamp 1, that is, the ring axis 14 of the press rings 11a through 11g, proceeding outward, is extended as far as the outermost press ring 11g. The resulting wave-shaped expansion of the piece of dough 6 causes an enlargement of the surface of the piece of dough 6 in the radial direction and the generating of the resulting pastry or pizza base. After lowering of the final press ring 11g or of the largest press ring 11g, it is kept in position, so that the dough flows into the border ring 12, which may happen to be present, and forms the edge of the pastry. The wave-shaped lowering and re-elevation of the press rings 11a through 11g thus causes an advantageous flowing movement of the dough of the piece of dough 6 without tearing it or causing unfavorable impacts on the dough.

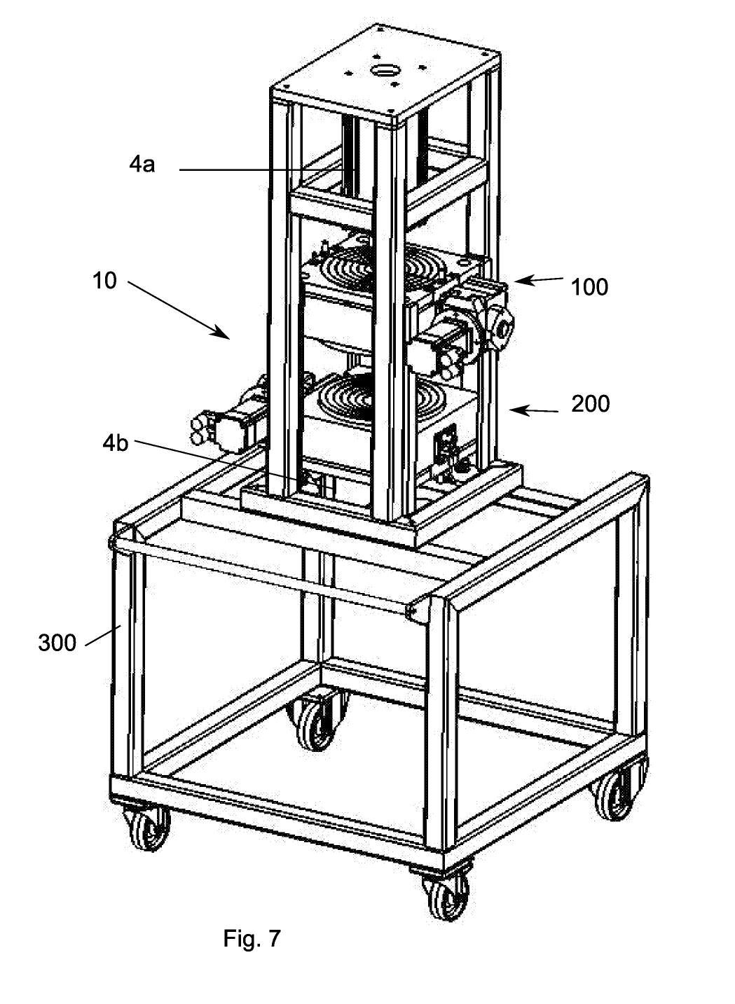

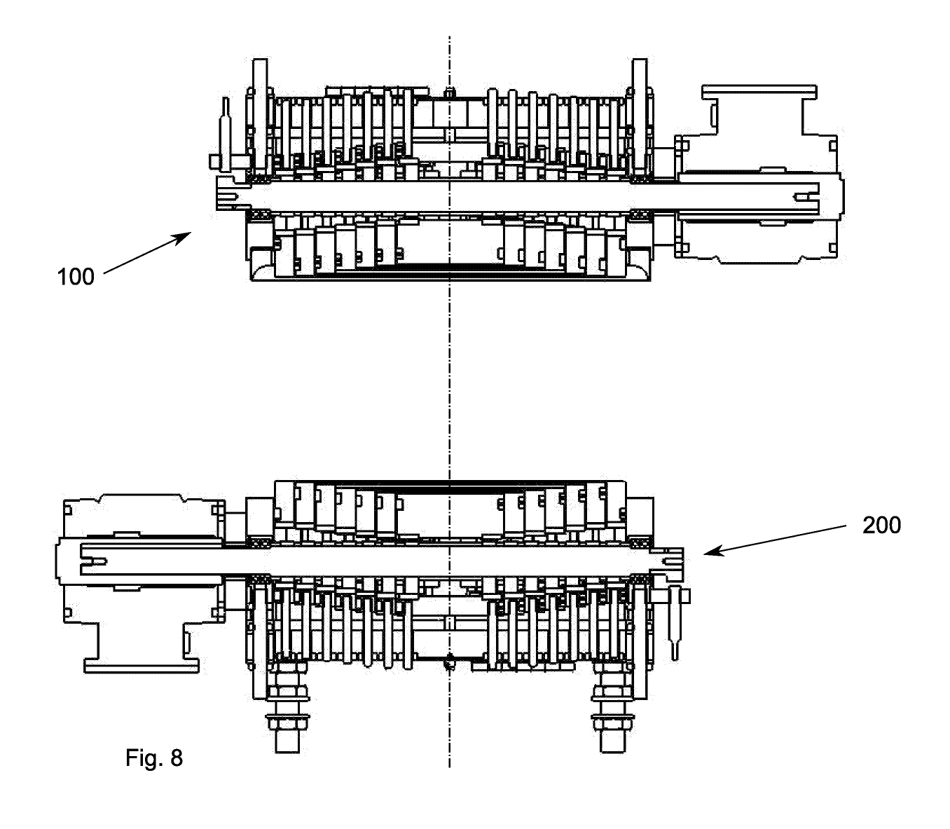

FIG. 7 shows an additional embodiment of the device 10 in perspective view. The device 10 comprises two pressure stamps 100, 200, which are positioned on a movable frame, in this embodiment a roller wagon 300. The first pressure stamp 100 here is disposed with respect to the second pressure stamp 200, such that the ring axes of the press rings 111a through 111g of the first pressure stamp 100 and the press rings 211a through 211g of the second pressure stamp 200 are disposed concentric to one another. The press rings 111a through 111g of the first pressure stamp 100 or the front surface 113 of the first pressure stamp 100 point to the front surface 213 of the second pressure stamp 200 or the front surface of the press rings 211a through 211g of the second pressure stamp. The press rings 111a through 111g of the first pressure stamp 100 or the press rings 211a through 211g of the second pressure stamp 200 are thus movable in each case toward the opposite press ring of the opposite pressure stamp 100, 200. In this embodiment of the inventive device 10, the first pressure stamp 100 is the support or abutment of the second pressure stamp 200, or the second pressure stamp 200 is the support or abutment of the first pressure stamp 100. In this embodiment of the inventive device 10, a piece of dough 6 is placed on the second pressure stamp 200 and the described pressing process is simultaneously performed by both pressure stamps 100, 200, either in a time-staggered manner or synchronized. The disposal of the two pressure stamps 100, 200 makes possible a variable shape of the pastry or a differentiated thickness distribution of the pizza base or of the pastry over the diameter. The pressure stamps 100, 200 are each fastened to an adjustment device 4a or 4b, such that the adjustment devices 4a and 4b are configured by a hydraulic cylinder. The adjustment device 4a and 4b allow the adjustment of the pressure stamp 100, 200 with respect to one another. FIG. 8 shows a section view of the device 10 described in FIG. 7, such that the adjustment devices 4a, 4b and the roller wagon 300 or the frame are not illustrated. The second pressure stamp 200 here is configured identically to the first pressure stamp 100, such that the second pressure stamp 200 comprises no border ring 12. The arrangement of the two pressure stamps 100, 200 makes possible an improved wave-shaped kneading apparatus, such that both pressure stamps 100, 200, in synchronized manner, proceeding from the center outward, perform a wave-shaped kneading motion and uniformly reshape any piece of dough 6 that may be situated between them into a pizza base or other pastry.

As an alternative to the illustrated press rings 11a through 11g, a different number of press rings may be available, such that the thickness of the press rings or the shape, in particular the front surface, can also be profiled.

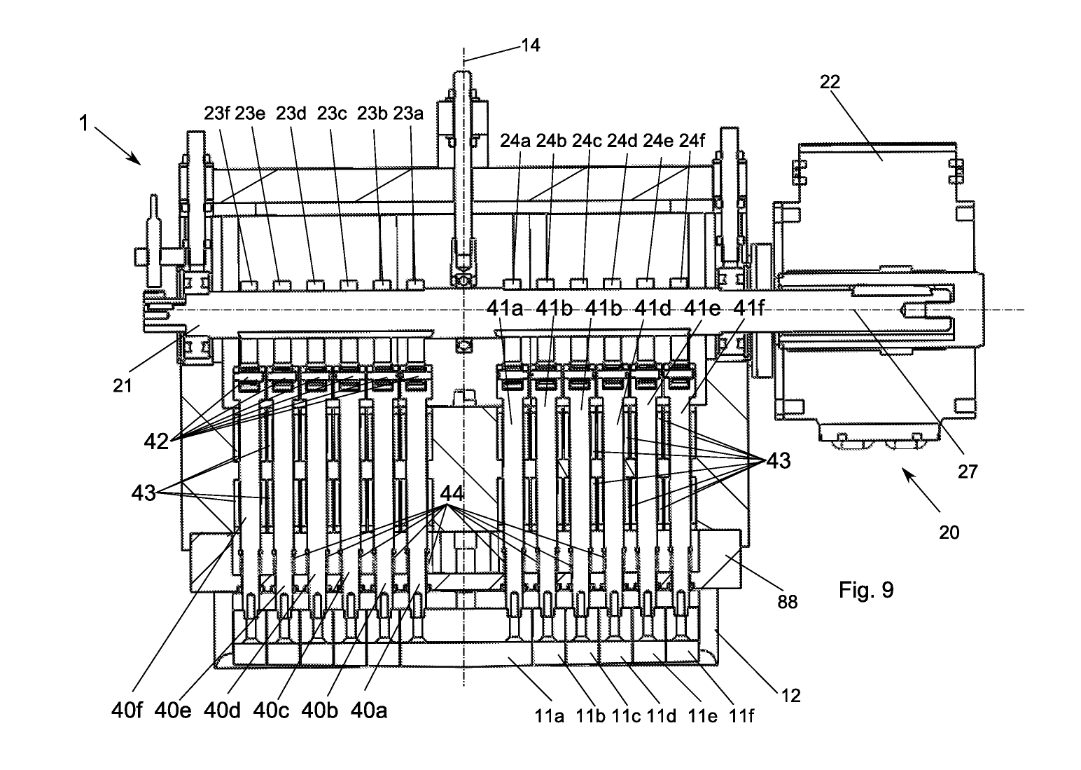

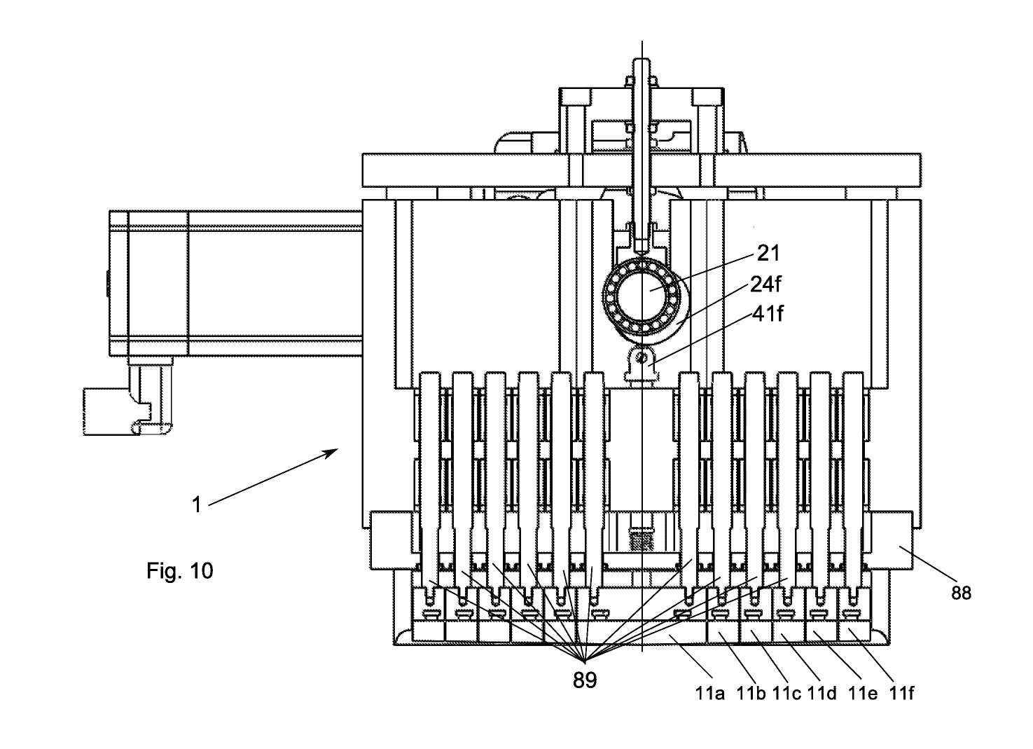

FIGS. 9 and 10 show an alternative embodiment of the device 10 in two section views. The pressure stamp 1 comprises a camshaft 21, which is disposed perpendicular to the ring axis 14 of the press rings 11a through 11f. The press rings 11a through 11f can be moved in the direction of the ring axis 14. The camshaft 21 includes twelve cams 23a through 23f and 24a through 24f, such that in each case two of the cams 23a through 24f are equal in configuration. Thus, for example, the cams 23a and 24a, which are disposed diametrically opposite the ring axis 14 on the camshaft 21, are of identical configuration, that is, they have the same elevation or eccentricity. The camshaft 21 in this embodiment comprises six identically configured cam pairs 23a, 24a through 23f, 24f. The pressure stamp of the device 10 comprises a number of pressure rods 40a through 41f corresponding to the number of cams 23a through 24f, such that the pressure rods 40a through 41f are contiguous with the cams 23a through 23f. The pressure rods 40a through 41f are bolted together with the press rings 11a through 11f at the end opposite the cams 23a through 24f, such that in each case one press ring 11a through 11f is connected with two pressure rods 40a through 41f, which preferably are disposed on two diametrically opposite points of the press rings 11a through 11f. In the embodiment of the pressure stamp 1 of the device 10, shown in FIG. 9, the cam 23a, for instance, is configured identically with cam 24a, which are disposed on the camshaft 21 diametrically opposite the ring axis 14. The cams 23a and 24a are each connected by a pressure rod 40a or 41a with the first press ring 11a. In addition, the cam 23b is thus identical in configuration with the cam 24b and, corresponding to the cam 23a and 24a, connected with the press ring 11b by two pressure rods 40b and 41b. Corresponding to the cams 23a and 24a, the cams 23c through 23f and 24c through 24f are also each in pairs identically configured and, diametrically opposite the ring axis 14, disposed on the camshaft 21 and connected by corresponding pressure rods 40c through 40f and 41c through 41f with the press rings 11c through 11f. The pressure rods 40a through 41f are each contiguous at one end with the cams 23a through 24f and are connected on the opposite end with the press rings 11a through 11f by a screw connection. On the end of the pressure rods 40a through 41f contiguous with the cams 23a through 24f, a roller 42 is positioned, which in each case is mounted on the respective pressure rods 40a through 41f. The rollers 42 are each contiguous with the periphery of the respective cam 23a through 24f, such that the respective roller 42 rolls out upon the rotation of the camshaft 21 on the periphery of the respective cam 23a through 24f. Upon rotation of the camshaft 21 and the connected rotation of the cams 23a through 24f, the pressure rods 40a through 41f are moved along the ring axis 14 and thus the press rings 11a through 11f are each likewise moved or extended along the ring axis 14 by the pressure rods 40a through 41f connected with the press rings 11a through 11f.

As illustrated in FIG. 9, the pressure rods 40a through 40f can be connected on the housing of the pressure stamp 1 or of the device 10 and guided, such that the pressure rods 40a through 41f are preferably guided by a guide sheath 43, which is supported in the housing of the pressure stamp 1 or the device 10. As shown in FIG. 9, two guide sheaths 43 also can be provided for each pressure rod 40a through 41f, said sheaths being positioned parallel to the ring axis 14. Alternatively, other configurations of the guides can also be selected or the pressure rods 40a through 41f can be movably positioned by other guides known in the prior art.

Preferably the pressure rods 40a through 41f can each be pressed by means of a spring in the direction of the camshaft 21 or cams 23a through 24f, and thus the pressure rods 40a through 41f are constantly contiguous with the periphery of the respective cams 23a through 24f. FIG. 9 demonstrates this with a preferred embodiment, in which the spring is configured as a pressure spring 44, which is disposed in each case on the end of the pressure rods 40a through 41f that is close to the press ring 11a through 11f. The respective pressure spring 44 is supported on a support plate 88 supported on the housing of the pressure stamp 1 and on a protrusion of the respective pressure rods 40a through 41f, and presses the respective pressure rod 40a through 41f in the direction of the respective cam 23a through 24f. Alternatively, a corresponding configuration can also be provided by means of tension springs or other force-exerting elements.

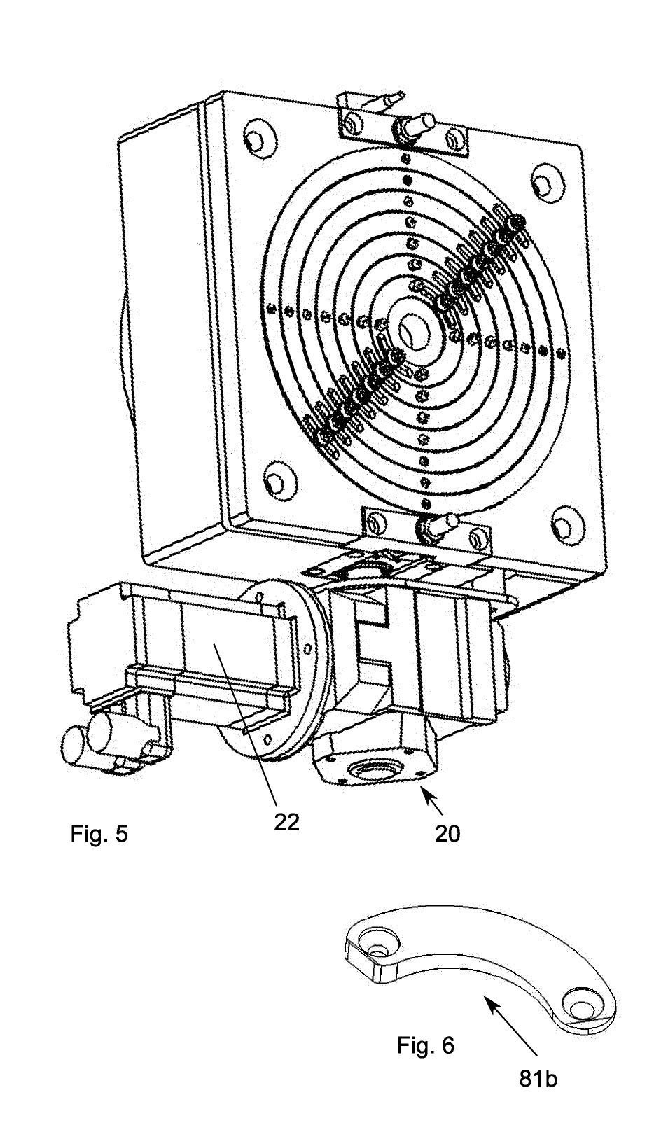

FIG. 10 shows a section view in accordance with FIG. 9, such that the section axis is rotated in position by 90 degrees, thus perpendicular to the axis of the camshaft 21. In the perpendicular axis to the camshaft 21, for each press ring 11a through 11f two guide pins 89 are in place, which are steered by means of guide sheaths 43, corresponding to the pressure rods 40a through 41f on the housing of the pressure stamp 1 of the device 10. The guide pins 49 make possible a more precise steering of the respective press rings 11a through 11f, so that they can be moved uniformly in the direction of the ring axis 14. Corresponding to the embodiments in FIGS. 1 through 6 and FIGS. 7 and 8, analogously to the relevant method, a piece of dough 6, with the help of the pressure stamp 1 of FIG. 9 or FIG. 10, is shaped one piece at a time by successive lowering of the press rings 11a through 11f and by applying pressure forces a pastry, in particular a pizza base, is formed.

As depicted in FIG. 7 and FIG. 8, the embodiment of the pressure stamp 1 of FIG. 9 and FIG. 10 can also be analogously duplicated and placed in opposite position along a vertical axis.

As an alternative to the illustrated embodiments, the force transmission between cam and the press rings or the pressure rods can also be configured by a gliding element, for example plastic or by means of rollers or other configurations to reduce wear. Alternatively, separation of the shaped pastry or of the piece of dough 6 from the press rings or the pressure stamps 1 can also be provided by means of a separator element, such as for example oil or flour. Alternatively to the indicated propulsion methods, the adjustment device can also take the form of an eccentric tappet, curved disk, chains, toothed rack or the like or could be a hydraulic cylinder, a pneumatic cylinder or linear motor.

Alternatively, for cleaning purposes, the stamp can be adapted for disassembly without tools, or a basic unit can be operated with various stamp sizes in order to be able to produce different pizza sizes, with and without borders.

1. A method for treating dough, in particular for producing pizza bases, wherein a piece of dough is applied on a support and pressure is applied to the piece of dough by means of a pressure stamp, which comprises a number of concentrically arranged press rings, so that the dough flows, wherein the press rings are extended one after the other outwardly in a staggered manner from the center of the press rings in the direction of the support such that the surface of the piece of dough is increased.

2. The method according to claim 1, wherein respectively adjacent press rings, proceeding outward one after the other from the center of the pressure stamp, are applied to the dough and shape it, such that after applying the respective adjacent press rings, they are withdrawn again so that at all times only a portion of the press rings, are in contact with the piece of dough.

3. The method according to claim 1, wherein the pressure of the press rings is selected so that, after extending the radially outermost of the press rings, the piece of dough has the predetermined shape of the pastry.

4. The method according to claim 1, wherein the distance between the individual press rings and the support of the piece of dough and/or the duration and/or the force of the pressing is predetermined for every press ring before and/or during the pressure process.

5. A device for performing the method according to claim 1, having a pressure stamp including a number of press rings arranged concentrically one after the other,
such that the device comprises a support for the pressure stamp on which a piece of dough can be applied,
wherein a propulsion device is provided, by which the press rings can be moved along their ring axis in telescopic manner independently of one another from a first position into a second position.

6. The device according to claim 5, wherein each of the press rings situated closer in each case to the ring axis has a slightly smaller outer diameter than the inner diameter of the adjacent press ring farther removed from the ring axis and such that the press rings can be slid inside one another.

7. The device according to claim 6, wherein the press rings are disposed in coplanar manner in the first position in a plane and configure a flat front surface of the pressure stamp and in the second position are at different distances from the support and/or the press rings configure, with the support a negative shape of the pastry to be produced.

8. The device according to claim 5, wherein the propulsion device includes a camshaft propelled by a motor, such that by rotating the camshaft the press rings can be moved from the first position along the ring axis in telescopic manner into the second position.

9. The device according to claim 8, wherein the press rings include a recess, which completely extends through them and runs radially to the press rings, such that the camshaft is inserted into the recess coaxially to the path of the recess and at least one cam of the camshaft impacts a press ring in each case and is contiguous with it in the recess.

10. The device according to claim 9, wherein the recess is of round configuration and the cams are configured in such a way that each cam is supported in each case on two radially opposite points of the wall of the recess.

11. The device according to claim 5, wherein the press rings include a recess, running radially, which completely extends through them, such that the camshaft is inserted into the recess and positioned coaxially to the recess and extends over the entire recess above the press rings, such that the camshaft impacts every press ring with two identically configured cams at two points diametrically opposite the ring axis of the press rings.

12. The device according to claim 5, wherein at least one restricting device is provided, which restricts the sliding of the press rings toward one another along the ring axis and/or determines the distance of the press rings from the support.

13. The device according to claim 12, wherein the restricting device is configured by at least one wedge, such that the wedge is disposed between a cam and the press ring.

14. The device according to claim 12, wherein the press rings can rotate about their ring axis
that a wedge pair is disposed between each press ring and the cam contiguous with the respective press ring at two radially opposite points of the wall of the recess,
that the first wedge and the second wedge of the wedge pair are configured as a wedge ring and have the same center diameter as the press ring on which the respective wedge is disposed and are mounted congruently with it,
that the first wedge and the second wedge each include over a portion a varying thickness in the direction toward the ring axis of the press rings and include with the respective cam a contact plane disposed steeply with respect to the radius of the press rings, such that the contact planes of the first wedge and of the second wedge run parallel to one another with the respective cam and such that the distance of the respective press ring to the support can be modified by rotation of the press rings.

15. The device according to claim 5, wherein every press ring can be moved with the cams in each case by a pressure rod that is contiguous with each of the cams, such that the pressure rods are disposed in such a way that upon rotation of the camshaft the press rings can be moved from the first position along the ring axis in a telescopic manner, into the second position.

16. The device according to claim 15, wherein the camshaft is disposed perpendicular to the ring axis and intersects it, such that the camshaft in each case includes two identically configured cams which are disposed on the camshaft diametrically opposite and such that in each case a press ring can be movably connected with a cam by means of a pressure rod and can be movably connected with the second identically configured cam by means of an additional pressure rod.

17. The device according to claim 15, wherein the pressure rods include in each case a roller that is contiguous with the periphery of the respective cam on the end contiguous with the cams, such that the respective roller is disposed in such a way that the respective roller rolls along the periphery of the respective cam upon rotation of the camshaft.

18. The device according to claim 15, wherein the pressure rod are disposed parallel to the ring axis, such that the press rods are each steered in at least one guide sheath so that said guide sheath is supported each time on the housing of the device or of the pressure stamp.

19. The device according to claim 15, wherein the pressure rods are each force-impacted by means of a spring, in particular a pressure spring, such that the respective spring is configured and disposed in such a way that the respective pressure rod can be pressed in the direction of the cams.

20. The device according to claim 5, wherein the pressure stamp includes a border ring, such that said border ring includes a negative shape of the border of the pastry produced by the device.

21. The device according to claim 20, wherein the border ring includes a greater diameter than the largest of the press rings or the border ring is disposed on the largest of the press rings.

22. The device according to claim 5, wherein at least one separator element and/or a shape is disposed between the press rings and the support.

23. The device according to claim 5, wherein the device includes two identically configured pressure stamps, such that the two pressure stamps are situated opposite one another and the press rings of the first pressure stamp and the press rings of the second pressure stamp are disposed concentrically to one another and such that the first pressure stamp and the second pressure stamp in each case constitute the support of the other pressure stamp.

24. The device according to claim 23, wherein the first pressure stamp and/or the second pressure stamp are disposed on a movable frame.

25. The device according to claim 24, wherein the distance between the first pressure stamp and the second pressure stamp can be adjusted.

26. The device according to claim 5, wherein said device includes at least one adjustment device, such that said adjustment device is supported on the pressure stamp and such that said pressure stamp can be moved by the adjustment device along the ring axis, or
that the device includes two adjustment devices, whereby the first adjustment device is supported on the first pressure stamp and the second adjustment device is supported on the second pressure stamp and such that the first pressure stamp and the second pressure stamp can be moved by the adjustment device along the ring axis of the respective pressure stamp.

27. The device according to claim 26, wherein the adjustment device, is a hydraulic cylinder, a pneumatic cylinder or a linear motor.
